(19) United States
(12) Patent Application Publication
(10) Pub. No.: US 2005/0288079 A1
(43) Pub. Date: Dec. 29, 2005

(54) Self-propelled cleaner

(75) Inventor: Takao Tani, Osaka (JP)

Correspondence Address: YOKOI & CO. U.S.A., INC., 13700 MARINA POINTE DRIVE, # 1512, MARINA DEL RAY, CA, 90292, US

(73) Assignee: Funai Electric Co., Ltd., Osaka (JP)

(21) Appl. No.: 11/166,396

(22) Filed: Jun. 23, 2005

(30) Foreign Application Priority Data
Jun. 25, 2004 (JP) JP2004-188394

(51) Int. Cl. A63F 9/24

(52) U.S. Cl. 463/1

(57) ABSTRACT

A self-propelled cleaner which is more attractive as a playmate. A game control processor makes a sound output processor issue a prescribed successful capture message when a human body detection processor detects a player in motion after the end of each cycle of a prescribed game message repeatedly issued by the sound output processor at prescribed times. Also it makes an imaging device take an image of the player and makes an image display processor display the image. If a predetermined number of players are detected or if it is detected that a given game end key on the cleaner body has been pressed while the game message is being issued, it ends the game. As a consequence, the self-propelled cleaner not only functions as a cleaner but also as an opponent for a human player in a given game, taking full advantage of its self-propelling function.

### BACKGROUND OF THE INVENTION

1. Field of the Invention

This invention relates to a self-propelled cleaner comprising a body with a cleaning mechanism and a drive mechanism capable of steering and driving the cleaner.

2. Description of the Prior Art

A cleaning robot for home use which enables the user to play a game using an RF tag has been known (for example, the one disclosed in Published Japanese translation of PCT international publication for patent application 2003-515210).

Also, a cleaning toy which can also be used as an ornament or a toy capable of speaking interactively while moving its limb-like parts has been known (for example, the one disclosed in JP-A 2000-135186).

In the cleaning robot as disclosed in Published Japanese translation of PCT international publication for patent application 2003-515210, it is necessary to prepare a special RF tag and make the cleaning robot for home use learn the RF tag in a training mode. This means that it is troublesome to make the cleaning robot ready for a game and also the robot must be an expensive model with a learning function.

The cleaning robot as disclosed in JP-A 2000-135186, which is usually used as an ornament, simply makes a specific sound in response to a call from a human being, runs around in a room or moves its limb-like parts occasionally. Thus, although it may be useful as an ornament or pet, its attractiveness as a playmate is insufficient.

### SUMMARY OF THE INVENTION

This invention has been made in view of the above problem and provides a highly value-added self-propelled cleaner which takes full advantage of its self-propelling capability.

In order to achieve the above object, according to one aspect of the invention, a self-propelled cleaner includes a body having a cleaning mechanism with a suction motor for vacuuming up dust and a drive mechanism with drive wheels at the left and right sides of the body whose rotation can be individually controlled for steering and driving the cleaner, and can perform a game function. Also, it includes: a sound output processor which can make a prescribed sound; a human body detection processor which checks whether there is a human body moving nearby; an imaging device which takes an image and outputs a taken image as image data; an image display processor which displays an image based on the image data; a game control processor which makes the sound output processor issue a prescribed successful capture message when the human body detection processor detects a player in motion after the end of each cycle of a prescribed game message repeatedly issued by the sound output processor at prescribed times and makes the imaging device take an image of the player and makes the image display processor display the image and, when a predetermined number of players are detected or when it is detected that a given game end key provided on the body has been pressed while the game message is being issued, ends the game; and a human body detection ability adjustment processor which adjusts the human body detection processor's ability of detecting a player in motion, in plural steps.

In the invention as constituted above, the self-propelled cleaner includes a body having a cleaning mechanism with a suction motor for vacuuming up dust and a drive mechanism with drive wheels at the left and right sides of the body whose rotation can be individually controlled for steering and driving the cleaner, and can perform a game function.

The game control processor controls the constituents as follows. The game control processor makes the sound output processor issue a prescribed successful capture message when the human body detection processor detects a player in motion after the end of each cycle of a prescribed game message repeatedly issued by the sound output processor at prescribed times. Further, it makes the imaging device take an image of the player and makes the image display processor display the image. In other words, if the player is detected because he/she does not stop moving even after the end of the game message, he/she is considered to have been captured by the self-propelled cleaner. Thanks to output of the successful capture message and display of the image, it is easy to know which player has been detected.

The game control processor ends the game when the human body detection processor has detected a predetermined number of players or when it is detected that the given game end key provided on the body has been pressed while the game message is being issued. In other words, if a player presses the game end key while the game message is being issued, the player wins and the game is over. On the other hand, if the prescribed number of players are captured before the game end key is pressed, the self-propelled cleaner wins and the game is over.

The human body detection ability adjustment processor is used to adjust the human body detection processor's ability of detecting a player in motion, in plural steps. Therefore, the player can enjoy the game in a manner which is suitable for his/her age and/or game skill.

As mentioned above, in this invention, the self-propelled cleaner is more attractive because it can function as an opponent for a human player in a given game.

According to another aspect of the invention, a self-propelled cleaner has a body with a cleaning mechanism, and a drive mechanism capable of steering and driving the cleaner and can perform a game function. It includes: a sound output processor which can make a prescribed sound; a human body detection processor which checks whether there is a human body moving nearby; and a game control processor which, when the human body detection processor detects a player in motion after the end of a prescribed game message issued by the sound output processor, notifies the outside of that detection, and when the human body detection processor detects a predetermined number of players or when a given instruction to end the game is received from the outside while the game message is being issued, ends the game.

In the above constitution, the self-propelled cleaner has a body with a cleaning mechanism and a drive mechanism capable of steering and driving the cleaner and can perform a game function.

Concretely, when the human body detection processor detects a player in motion after the end of a prescribed game message issued by the sound output processor, the game control processor outputs a notification message of that detection to the outside. In other words, when the player who has not stopped moving after the end of the game message is detected, the player is considered to have been captured. The detection of the player is confirmed by output of the notification message. Then, when the human body detection processor detects a predetermined number of players or when a given instruction to end the game is received from the outside while the game message is being issued, the game control processor ends the game. In other words, when the player enters the above instruction into the self-propelled cleaner while the game message is being issued, the player wins; on the other hand, when all the players are captured before the game end key is pressed, the self-propelled cleaner wins. The game is thus ended.

As described above, in this invention, since the self-propelled cleaner has a function to perform the role of an opponent for a human player in a given game, it is more attractive.

According to another aspect of the invention, the human body detection processor's ability of detecting a player in motion can be adjusted in plural steps.

In a human versus machine game, the machine has an advantage over the human being in terms of the speed of response to sound or the like. Therefore, when the human body detection processor's detection ability is adjustable, the game can be evenly matched like a match between human players and be more exciting.

According to another aspect of the invention, as a concrete example of output of a message to notify the outside of the detection, when the human body detection processor detects a player in motion, the sound output processor issues a prescribed message notifying of the successful capture. When such successful capture message is outputted, the player can know that he/she has moved after the end of the game message.

According to another aspect of the invention, when the human body detection processor detects a player in motion, the game control processor makes a given imaging device take an image of the player and makes a given image display processor display the image. If there are more than one player, it may be impossible to identify which player has been captured, only by a successful capture message. If an image of a detected player is taken and displayed as mentioned above, who has moved after the end of the game message is objectively determined and the function of the self-propelled cleaner as the opponent in the game is more reliable. In addition, since display of an image of a player means dropout of the player from the game, each player will try to avoid it and get more involved in the game, which will make the game more exciting.

According to another aspect of the invention, a wireless LAN communication device which can transmit given information to the outside is provided and, when the human body detection processor detects a player in motion, the game control processor makes a given imaging device take an image of the player and sends the acquired image data to the outside through the wireless LAN communication device.

It is also possible that when a player in motion is detected and an image of the player is taken, the image may be displayed on an external device. In order to achieve this, the image data acquired from the image is transmitted through the wireless LAN communication device to the outside. As a consequence, the image based on the image data is displayed outside the self-propelled cleaner on a computer or other external device which is connected with an access point as a base station for wireless LAN communication.

The above explanation assumes that the self-propelled cleaner performs the role of the chaser in the game. However, it is also possible that the human player or user performs the role of the chaser, namely the self-propelled cleaner performs the role of a chasee, or a player to be captured, in the game.

Therefore, according to another aspect of the invention, the self-propelled cleaner includes a travel route calculation processor which acquires and stores map information on a room while the cleaner is traveling around the room for cleaning it and acquires positional information on a given goal in the map information and calculates the travel route from the present position to the goal position; and a sound recognition processor capable of recognizing sound. When the chasee mode in a game is selected, the game control processor starts traveling toward the goal along the travel route by means of the drive mechanism as soon as the sound recognition processor recognizes the first sound of a game message uttered by a player, and stops the traveling as soon as the sound recognition processor recognizes the last sound of the game message and the human body detection processor detects that the player turns around, and ends the game when the goal is reached or when the sound recognition processor recognizes a prescribed successful capture message uttered by a player.

When the self-propelled cleaner performs the role of a chasee, first the travel route calculation processor acquires positional information on a given goal in the map information on a room which it stores while the cleaner is traveling around the room for cleaning it, and calculates the travel route from the present position to the goal position. Then, the game control processor starts traveling toward the goal along the travel route by means of the drive mechanism as soon as the sound recognition processor recognizes the first sound of a game message uttered by a player as the chaser. The game control processor stops the traveling as soon as the sound recognition processor recognizes the last sound of the game message and the human body detection processor detects that the player turns around. In other words, the self-propelled cleaner moves while the player as the chaser is uttering the game message and not facing it so that its distance to the goal is reduced. When the goal is reached or when the sound recognition processor recognizes a prescribed successful capture message uttered by a player, the game control processor ends the game.

In the above game, if the goal is reached, the self-propelled cleaner is the winner, and if a successful capture message is recognized, it is the loser. When the human body detection processor's ability of detecting that the player turns around is adjustable, the player can enjoy the game in which the self-propelled cleaner performs the role of the chasee, in a manner suitable for his/her age and/or game skill.

As explained so far, the invention provides a highly value-added self-propelled cleaner to which the user feels the kind of attachment that he/she would never feel to conventional self-propelled cleaner robots because it performs not only as a cleaner but also as a playmate which is a good opponent for a human player in a given game based on its self-propelling capability.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of an AF passive sensor unit;

FIG. 4 illustrates the position of a floor relative to the AF passive sensor unit and how ranging distance changes when the AF passive sensor unit is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a traveling control process;

FIG. 8 is a flowchart showing a cleaning traveling process;

FIG. 9 shows a travel route in a room;

FIG. 10 shows the composition of an optional unit;

FIG. 11 shows the external appearance of a marker;

FIG. 12 is a flowchart showing a mapping process;

FIG. 13 illustrates how mapping is done;

FIG. 14 illustrates how map information on each room is linked after mapping;

FIG. 15 is a flowchart showing a game process in which the robot is the tagger or chaser;

FIG. 16 is a flowchart showing a game process in which the robot is a player;

FIG. 17 is a perspective view showing another embodiment as seen from its front left side; and

FIG. 18 is a perspective view showing another embodiment as seen from its rear right side.

### DESCRIPTION OF THE PREFERRED EMBODIMENTS

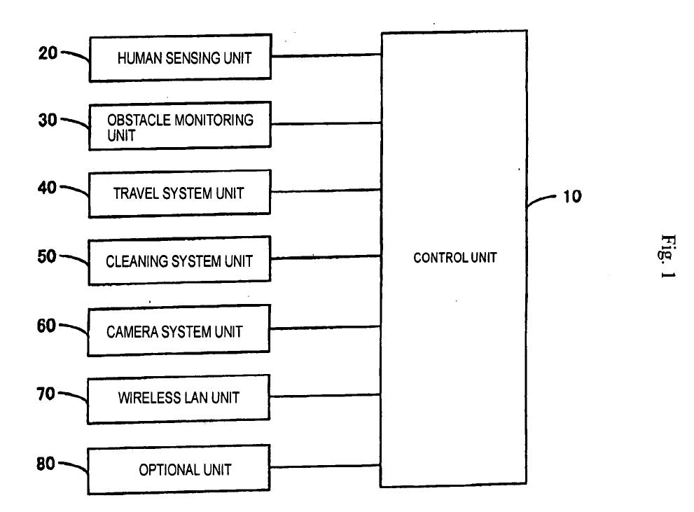

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a traveling system unit 40 for traveling; a cleaning system unit 50 for cleaning; a camera system unit 60 to take a photo of a given area; a wireless LAN unit 70 for wireless connection to a LAN; and an optional unit 80 including additional sensors and the like. The body of the cleaner has a low profile and is almost cylindrical.

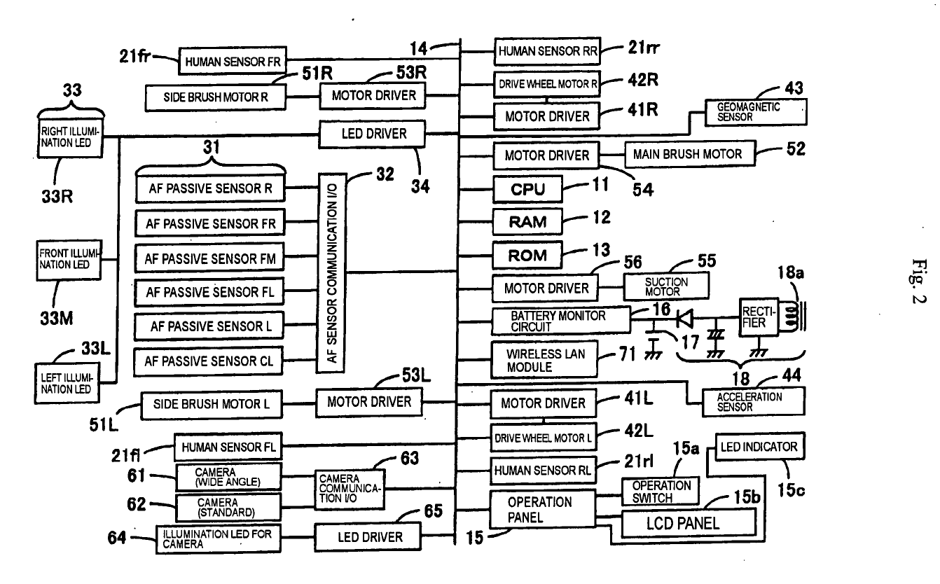

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel unit 15 on which many types of operation switches 15a, a liquid crystal display panel 15b, and LED indicators 15c are provided. Although the liquid crystal display panel 15b is a monochrome liquid crystal panel with a multi-tone display function, a color liquid crystal panel or the like may also be used instead of it.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1) where two of them are disposed obliquely at the left and right sides of the front of the body and the other two obliquely at the left and right sides of the rear of the body. Each human sensor 21 has an infrared light-receiving sensor that detects the presence of a human body based on change in the amount of infrared light received. When a human sensor 21 detects an irradiated object which changes the amount of infrared light received, it changes its status for output and thus the CPU 11 obtains the result of detection by the human sensor 21 via the bus 14. In other words, the CPU 11 acquires the status of each of the human sensors 21fr, 21rr, 21f1, and 21r1 at each predetermined time and detects the presence of a human body in front of the human sensor 21fr, 21rr, 21f1, or 21r1 by a change in the status.

Although the human sensors described above detect the presence of a human body based on change in the amount of infrared light, the human sensors which can be used here are not limited to this type. For example, if the CPU's processing capability is increased, it is possible to take a color image of a target area, identify a skin-colored area that is characteristic of a human body and detect the presence of a human body based on the size of the area and/or change.

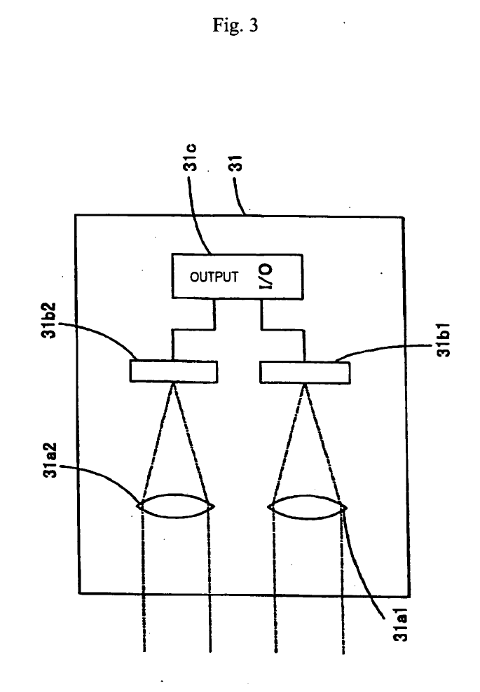

The obstacle monitoring unit 30 consists of an AF passive sensor unit 31 composed of ranging sensors for auto focus (hereinafter called AF) (31R, 31FR, 31FM, 31FL, 31L, 31CL); an AF sensor communication I/O 32 as a communication interface to the AF passive sensor unit 31; illumination LEDs 33; and an LED driver 34 to supply driving current to each LED. First, the construction of the AF passive sensor unit 31 will be described. FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

The CCD line sensors 31b1 and 31b2 each have a CCD sensor with 160 to 170 pixels and can output 8-bit data representing the amount of light for each pixel. Since there are two optical systems, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined as follows: data rows (4-5 pixels/row) in output image data are scanned, the difference between the address of an original data row and that of a discovered data row is found, and then reference is made to a difference-to-distance conversion table prepared in advance.

The AF passive sensors 31FR, 31FM, and 31FL are used to detect an obstacle in front of the cleaner while the AF passive sensors 31R and 31L are used to detect an obstacle ahead on the immediate right or left. The AF passive sensor 31CL is used to detect a distance up to the ceiling ahead.

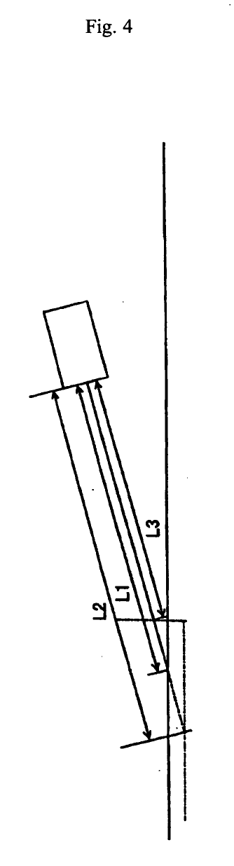

FIG. 4 shows the principle under which the AF passive sensor unit 31 detects an obstacle in front of the cleaner or ahead on the immediate right or left. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a step or floor level difference as indicated by the alternate long and short dash line in the figure, the ranging distance is expressed by L2. Namely, an increase in the ranging distance suggests the presence of a step. If there is a floor level rise as indicated by the alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx. 10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or step in a 30 cm wide area ahead of the cleaner. The detection area width varies depending on the sensor model and position, and the number of sensors should be determined according to the actually required detection area width.

Regarding the AF passive sensors 31R and 31L which detect an obstacle ahead on the immediate right and left, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

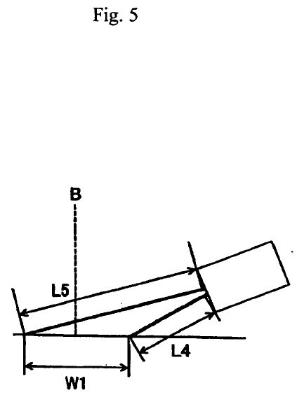

If the left and right sensors should be located so as to cover the leftward and rightward areas just before them respectively, they would have to be sharply angled with respect to the floor surface and the imaging range would be very narrow. As a consequence, more than one sensor would be needed at each side. For this reason, it is arranged that the left sensor covers the rightward area and the right sensor covers the leftward area in order to ensure a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a step or the like and the imaging range portion beyond the border line is used to detect a wall surface, where the border line of the body side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall surface can be detected more accurately.

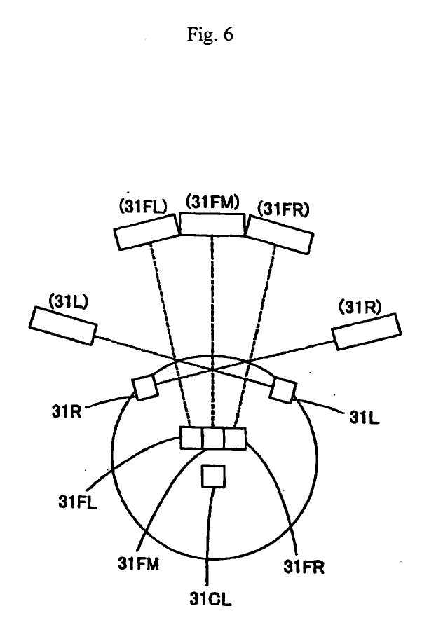

FIG. 6 shows how the AF passive sensors 31R, 31FR, 31FM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a front illumination LED 33M to illuminate the images from the AF passive sensors 31R, 31FR, 31FM, 31FL and 31L; and the LED driver 34 supplies a driving current to illuminate the images according to an instruction from the CPU 11. Therefore, even at night or in a dark place (under the table, etc), it is possible to acquire image data from the AF passive sensor unit 31 effectively.

The traveling system unit 40 includes: motor drivers 41R, 41L; drive wheel motors 42R, 42L; and a gear unit (not shown) and drive wheels which are driven by the drive wheel motors 42R and 42L. A drive wheel is provided at each side (right and left) of the body. In addition, a free rolling wheel without a drive source is attached to the center bottom of the front side of the body. The rotation direction and angle of the drive wheel motors 42R and 42L can be accurately controlled by the motor drivers 41R and 41L which output drive signals according to an instruction from the CPU 11. From output of rotary encoders integral with the drive wheel motors 42R and 42L, the actual drive wheel rotation direction and angle can be accurately detected. Alternatively, the rotary encoders may not be directly connected with the drive wheels but a driven wheel which can rotate freely may be located near a drive wheel so that the actual amount of rotation can be detected by feedback of the amount of rotation of the driven wheel even if the drive wheel slips. The traveling system unit 40 also has a geomagnetic sensor 43 so that the traveling direction can be determined according to the geomagnetism. An acceleration sensor 44 detects the acceleration velocity in the X, Y and Z directions and outputs the detection result.

The gear unit and drive wheels may be of any type; they may use circular rubber tires or endless belts.

The cleaning mechanism of the self-propelled cleaner consists of: side brushes located forward at both sides of the body which gather dust beside each side of the body in the advance direction and bring the gathered dust toward the center of the body; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

The camera system unit 60 has two CMOS cameras 61 and 62 with different viewing angles which are mounted on the front side of the body at different angles of elevation. It also has a camera communication I/O 63 which gives the camera 61 or 62 an instruction to take a photo and outputs the photo image. In addition, it has a camera illumination LED array 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the existence of an access point (not shown) and the access point should be connectable with a computer with a monitor installed in a room or an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Needless to say the card slot may be connected with another type of standardized card.

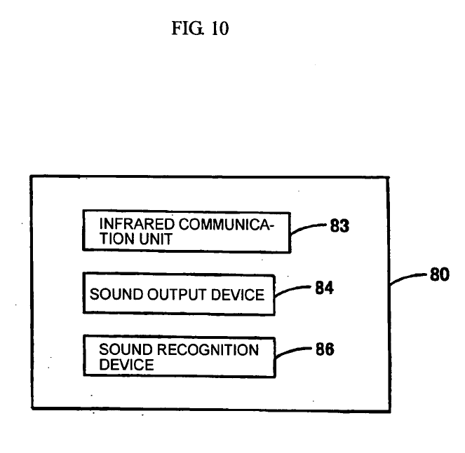

The optional unit 80 may include additional sensors as shown in FIG. 10. In this embodiment, it has an infrared communication unit 83, a sound output device 84 and a sound recognition device 86. The infrared communication unit 83 can receive an infrared signal as encoded positional data sent from a marker 85 (stated later) and decode the positional data and send it to the CPU 11. The sound output device 84, capable of issuing a given message to the player, has a speaker. In addition to voice sound, it may make siren or buzzer sound. The sound recognition device 86 has a microphone and checks whether the player has made a given sound.

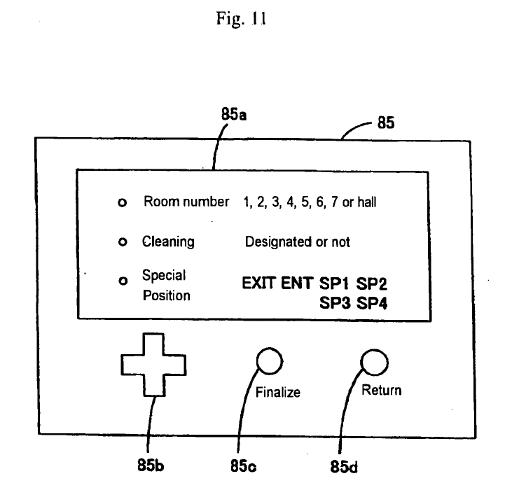

FIG. 11 shows the appearance of the marker 85 which has a liquid crystal display panel 85a, a cross key 85b, a Finalize key 85c and a Return key 85d on its external face. It incorporates a one-chip microcomputer, an infrared transmission/reception unit, a battery and so on. The one-chip microcomputer controls the display content on the liquid crystal display panel 85a according to the operation of the Finalize key 85c or Return key 85d and generates setup parameters in response to key operation to allow the infrared transmission/reception unit to output positional data depending on the parameters. In this embodiment, the following parameters are available: room numbers “1 to 7 and hall”; cleaning “designated (yes)” and “no”; and special positions “EXIT” (exit), “ENT” (entrance), “SP1” (special position 1), “SP2” (special position 2), “SP3” (special position 3), and “SP4” (special position 4). In the embodiment below, special positions 1 to 4 can be used as goal positions where the self-propelled cleaner performs the role of a chasee, or someone to be chased or captured in a game. However, the goal position is not limited to the position of the marker 85, as stated later. A flowchart necessary to specify these parameters does not require special expertise and can be prepared by a person with ordinary knowledge in the art.

Next, how the above self-propelled cleaner works will be described.

(1) Traveling Control and Cleaning Operation

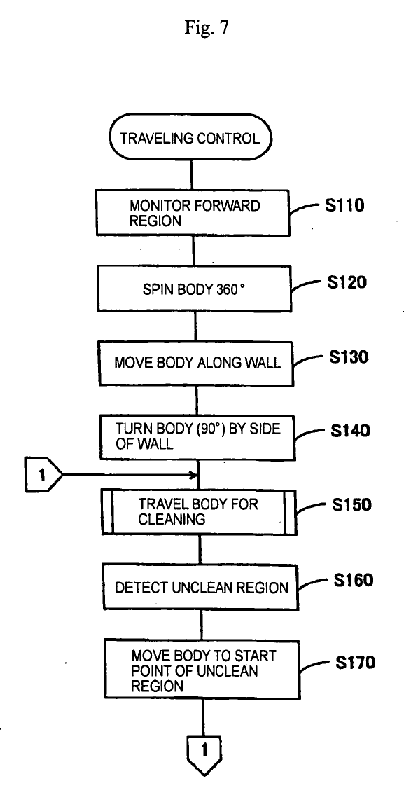

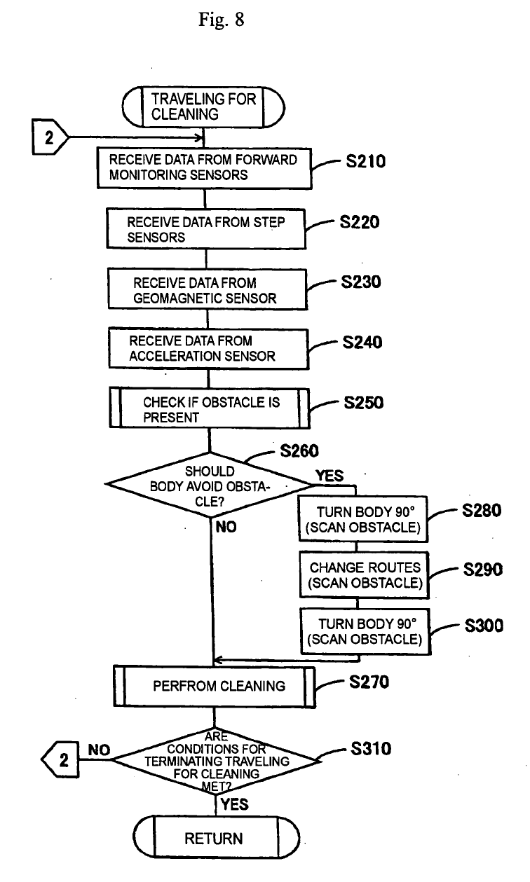

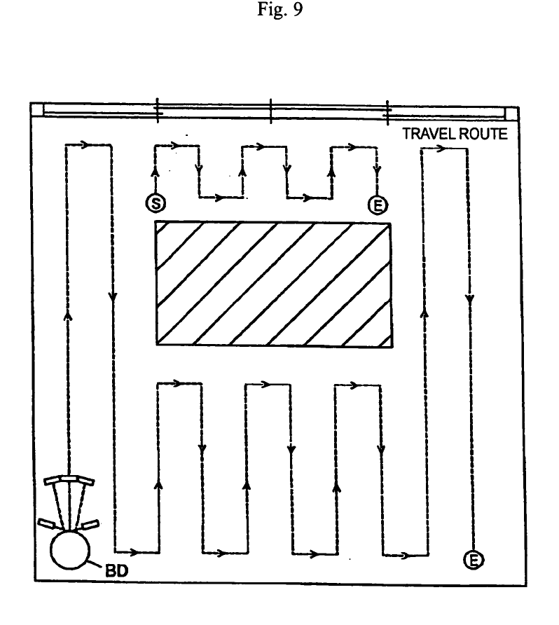

FIGS. 7 and 8 are flowcharts which correspond to a control program which is executed by the CPU 11; and FIG. 9 shows a travel route along which this self-propelled cleaner moves under the control program.

When the power is turned on, the CPU 11 begins to control traveling as shown in FIG. 7. At step S110, it receives the results of detection by the AF passive sensor unit 31 and monitors a forward region. In monitoring the forward region, reference is made to the results of detection by the AF passive sensors 31FR, 31FM and 31FL; and if the floor surface is flat, the distance L1 to the floor surface (located downward in an oblique direction as shown in FIG. 4) is obtained from images taken by the sensors. Whether the floor surface in the forward region corresponding to the body width is flat or not is decided based on the results of detection by the AF passive sensors 31FR, 31FM and 31FL. However, at this moment, no information on the space between the body's immediate vicinity and the floor surface regions facing the AF passive sensors 31FR, 31FM and 31FL is not obtained, so the space is a dead area.

At step S120, the CPU 11 orders the drive wheel motors 42R and 42L to rotate in different directions by equal amount through the motor drivers 41R and 41L respectively. As a consequence, the body begins turning on the spot. The rotation amount of the drive motors 42R and 42L required for 360-degree turn on the same spot (spin turn) is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body. The above dead area is almost covered (eliminated) by the results of detection obtained during this spin turn, and if there is no step or obstacle there, it is confirmed that the surrounding floor surface is flat.

At step 130, the CPU 11 orders the drive wheel motors 42R and 42L to rotate by equal amount through the motor drivers 41R and 41L respectively. As a consequence, the body begins moving straight ahead. During the straight movement, the CPU 11 receives the results of detection by the AF passive sensors 31FR, 31FM and 3FL and the body advances while checking whether there is an obstacle ahead. When a wall surface as an obstacle ahead is detected, the body stops a prescribed distance short of the wall surface.

At step S140, the body turns clockwise by 90 degrees. The prescribed distance short of the wall at step S130 corresponds to a distance which ensures that the body can turn without colliding the wall surface and the AF passive sensors 31R and 31L can monitor their immediate vicinity and rightward and leftward regions beyond the body width. In other words, the distance should be such that when the body turns 90 degrees at step S140 after it stops according to the results of detection by the AF passive sensors 31FR, 31FM and 31FL at step S130, the AF passive sensor 31L can at least detect the position of the wall surface. Before the body turns 90 degrees, the condition of its immediate vicinity should be checked according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning traveling steps in detail. Before advancing or moving forward, the CPU 11 receives the results of detection by various sensors at steps S210 to S240. At step S210, it receives forward monitoring sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives step sensor data (specifically the results of detection by the AF passive sensors 31R and 31L) which is used to judge whether or not there is a step in the immediate vicinity of the body in the traveling area. Also, while the body moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of geomagnetism at the cleaning start point is memorized and if an angle detected during traveling is different from the memorized angle, the amounts of rotation of the left and right drive wheel motors 42R and 42L are slightly differentiated to adjust the traveling direction to restore the original angle. If the angle becomes larger than the original angle of geomagnetism (change from 359 degrees to 0 degree is an exception), it is necessary to adjust the traveling direction to make it more leftward. Hence, an instruction is given to the motor drivers 41R and 41L to make the amount of rotation of the right drive wheel motor 42R slightly larger than that of the left drive wheel motor 42L.

At step S240, the CPU 11 receives acceleration sensor data (specifically the result of detection by the acceleration sensor 44) which is used to check the traveling condition. For example, if an acceleration in almost one direction is sensed at the start of rectilinear traveling, the traveling is recognized to be normal. If an acceleration in a varying direction is sensed, an abnormality that one of the drive wheel motors is not driven is suspected. If a detected acceleration velocity is out of the normal range, a fall from a step or an overturn is suspected. If a considerable backward acceleration is detected during forward movement, collision against an obstacle ahead is suspected. Although there is no direct acceleration control function (for example, a function to maintain a desired acceleration velocity by input of an acceleration value or achieve a desired acceleration velocity based on integration), acceleration data is effectively used to detect an abnormality.

At step S250, the system checks whether there is an obstacle, according to the results of detection by the AF passive sensors 31FR, 31FM, 31CL, 31FL, 31R and 31L which the CPU 11 have received at steps S210 and S220. This check is carried out for each of the forward region, ceiling and immediate vicinity. Here the forward region refers to an area ahead where detection for an obstacle or wall surface is made; and the immediate vicinity refers to an area where detection for a step is made and the condition of regions on the left and right of the body beyond the traveling width is checked (for presence of a wall, etc). The ceiling here refers to an area where detection is made, for example, for a door lintel, underneath the ceiling, which is next to a hall and might lead the body out of the room.

At step S260, the system evaluates the results of detection by the sensors comprehensively to decide whether to avoid an obstacle or not. As far as there is no obstacle to be avoided, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the instruction is always given during traveling and when the conditions to terminate traveling for cleaning are met, the CPU 11 stops traveling.

On the other hand, if it is decided that the body must avoid an obstacle (do escape motion), it turns clockwise 90 degrees at step S280. This is a 90-degree turn on the same spot which is achieved by giving an instruction to the drive wheel motors 42R and 42L through the motor drivers 41R and 41L respectively to turn them in different directions by the amount necessary for the 90-degree turn. Here, the right drive wheel should turn backward and the left drive wheel should turn forward. During the turn, the CPU 11 receives the results of detection by the AF passive sensors 31R and 31L as step sensors and checks for an obstacle. When an obstacle ahead is detected and the body turns clockwise 90 degrees, if the AF passive sensor 31R does not detect a wall ahead on the immediate right, it may be considered to have simply touched a forward wall, but if a wall surface ahead on the immediate right is still detected even after the turn, the body may be considered to get caught in a corner. In this case, if neither of the AF passive sensors 31R and 31L detects an obstacle ahead in the immediate vicinity during 90-degree turn, it can be thought that the body has not touched a wall but there is a small obstacle.

At step S290, the body advances to change routes or turn while scanning for an obstacle. It touches a wall surface and turns clockwise 90 degrees, then advances. If it has stopped short of the wall, the distance of the advance should be almost equal to the body width. After advance by that distance, the body turns clockwise 90 degrees again.

During the above movement, the forward region and leftward and rightward regions ahead are always scanned for an obstacle and the result of this monitoring scan is memorized as information on the presence of an obstacle in the room.

As explained above, a 90-degree clockwise turn is made twice. So, if the body should turn clockwise 90 degrees upon detection of a next wall ahead, it would return to its original position. Therefore, after it turns clockwise 90 degrees twice, it should turn counterclockwise twice and then clockwise twice, namely such turns should be made in alternate directions. This means that it should turn clockwise at an odd-numbered time of escape motion and counterclockwise at an even-numbered time of escape motion.

The system continues traveling for cleaning while scanning the room in a zigzag pattern and avoiding an obstacle as described so far. Then at step S310, whether or not it has reached the end of the room is decided. After the second turn, if the body has advanced along a wall and has detected an obstacle ahead, or if it has entered a region where it already traveled, it is decided that the body has reached the cleaning traveling termination point. In other words, the former situation can occur after the last end-to-end travel in the zigzag movement; and the latter situation can occur when a region left unclean is found as stated later and cleaning traveling is started again.

If either of these conditions to terminate traveling for cleaning is not met, the system goes back to step S210 and repeats the abovementioned steps. If either of the conditions is met, the system ends the cleaning traveling subroutine and returns to the process of FIG. 7.

After returning to the process of FIG. 7, at step S160, whether or not there is any region left unclean is decided from the collected information on the traveled regions and their surroundings. If an unclean region is found, the body moves to the start point of the unclean region at step S170 and the system returns to step S150 and starts cleaning traveling again.

Even if there are more than one unclean region here and there, each time the conditions to terminate traveling for cleaning as described above are met, detection for an unclean region is repeated until there is no unclean region.

(2) Mapping

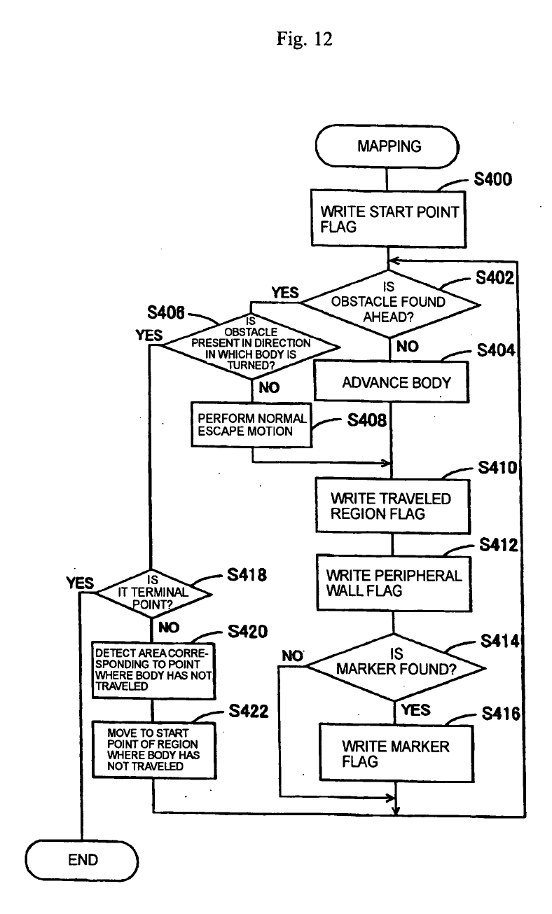

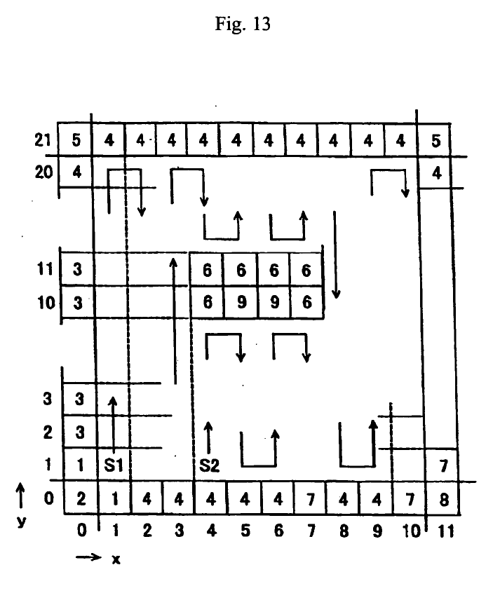

Various methods of detection for an unclean region are available. This embodiment adopts a method as illustrated in FIGS. 12 and 13.

FIG. 12 is a flowchart of mapping and FIG. 13 illustrates a mapping method. In this example, based on the above mentioned rotary encoder detection results, the travel route in the room and information on wall surfaces detected during traveling are written in a map reserved in a memory area. The presence of an unclean region is determined from the map by checking whether or not, in the map, the surrounding wall surface is continuous and the perimeters of obstacles in the room are all continuous and the body has traveled across all regions of the room except the obstacles.

The mapping database is a two-dimensional database which allows an address to be expressed as (x, y) where (1,1) denotes the start point region in a corner of the room and (n, 0) and (0, m) denote regions of hypothetical wall surfaces. As the body travels, the room is mapped where the room is divided into regions and each of the regions is a unit area whose dimensions are equal to the body's dimensions, or 30 cm×30 cm; in the mapping process, the regions are categorized into several groups: untraveled regions, cleaned regions, walls and obstacles.

At step S400, a start point flag is written. The start point (1,1) is a corner of the room as shown in FIG. 13. The cleaner body turns 360 degrees (spin turn) to confirm that there is a wall surface behind and on the left of it; and the system writes a wall flag [1] for unit areas (1,0) and (0,1) and writes a wall flag [2] for an intersection of walls (0,0). At step S402, the system checks whether or not there is an obstacle ahead and at step S404 the body advances by the distance equivalent to a unit area if there is no obstacle ahead. This advance involves cleaning as mentioned above. Concretely, when the cleaner body has moved by the distance equivalent to a unit area as indicated by rotary encoder output during cleaning traveling, this mapping process is performed synchronously and concurrently.

On the other hand, if it is decided that there is an obstacle ahead, whether there is an obstacle in the direction in which the body is going to turn is checked at step S406. The body escapes from the obstacle by a combination of a 90-degree turn, an advance and a 90-degree turn. The direction of turn is alternately changed every two turns as mentioned above (two clockwise turns, then two counterclockwise turns). If the next turn for escape should be clockwise and there is an obstacle ahead, whether or not the body can go rightward and turn is judged. In the early stage of cleaning, on the assumption that the rightward region is unclean and there is no obstacle in the direction in which the body is going to turn, normal escape motion is done at step S408.

After the above movements, at step S410, a traveled region flag is written for each unit area on which the body has traveled. Since a region on which the body has traveled (traveled region) is considered to be a region which has been cleaned, a flag which represents a cleaned region is written for it. At step S412, a peripheral wall flag which represents a peripheral wall is written for each unit area. When the body moves from unit area (1,1) to unit area (1,2), it is possible to judge whether unit areas (0,1) and (2,1) are a wall or not according to the results of detection by the AF passive sensors 31R and 31L. A flag which represents a wall is written for unit area (0,1) and a flag which represents the absence of a wall and an untraveled/unclean region is written for unit area (2,1).

In this example, an obstacle ahead is detected at the point of unit area (1,20) and by two 90-degree turns and an advance, the body moves to unit area (2,20) and changes its traveling direction 180 degrees. At this time, a flag [4] is written for each of unit areas (0,20), (2,20), (1,21) and (2,21). For unit area (0,21), a flag which represents a wall [5] is written based on the judgment that it is an intersection of walls (a point where walls meet). A traveled/cleaned region is also treated as an obstacle.

As the body advances, an obstacle on the right is detected at the points of unit areas (3,10) and (3,11) and a flag for an obstacle [6] is written. While the body moves across unit areas (3,1) to (3, 9), untraveled/unclean regions ahead on the right are detected and a corresponding flag is written for them. Similarly, when the body moves across unit areas (8,9) to (8,1) later, untraveled/unclean regions ahead on the right are detected and a corresponding flag is written for them.

When the body is at the point of unit area (4,12), an obstacle ahead is detected and an escape motion is done. Here, an obstacle flag has been written for unit area (4,11) and as it moves, an obstacle flag is written for unit area (4,11).

At step S414, whether or not there has been communication of positional data with the marker 85 is judged at the point of each traveled unit area; if there has been communication with the marker 85, a flag based on the marker information is written at step S416. For example, if the user has specified a particular unit area for a goal using operation keys 85b to 85d of the marker 85, as the body passes the unit area, the infrared communication unit 83 acquires that positional data and a flag representing a goal is written for that unit area.

After repeated advance and escape motions, an obstacle ahead on the left is detected at the point of unit area (10,20). In this case, unit area (10,20) is judged as part of a continuous wall and a wall flag [4] is also written for unit area (11, 20) and a wall intersection flag [5] is written for unit area (11, 21).

As a result of repeated advance and escape motions, an obstacle ahead is detected at the point of unit area (10,1) and an obstacle in the direction in which the cleaner body is going to turn is also detected. Hence, whether the travel termination point is reached or not is judged at step S418. At the point of unit area (10,1), an obstacle ahead and a wall on the left in the traveling direction are detected [7][8].

A primary factor which determines whether the traveling termination point has been reached or not is the presence or absence of a unit area for which an “untraveled/unclean” region flag is written. If there is no unit area for which an untraveled/unclean region flag is written, whether or not the wall flag written at the start point is continuously repeated to go round the room is checked. If so, the room map is scanned in both the X and Y directions to check for a region for which no flag is written. Unit areas for which an obstacle flag is written are considered as a continuous area like a wall and obstacle detection is thus finished.

If the cleaning traveling termination point has not been reached, an untraveled region is detected at step S420 and the body moves to the untraveled area start point at step S422 and the above process is repeated. When it is finally decided that the cleaning traveling termination point has been reached, mapping is completed. Upon completion of mapping, the walls and traveled regions of the room are clearly indicated and this is used as room map information.

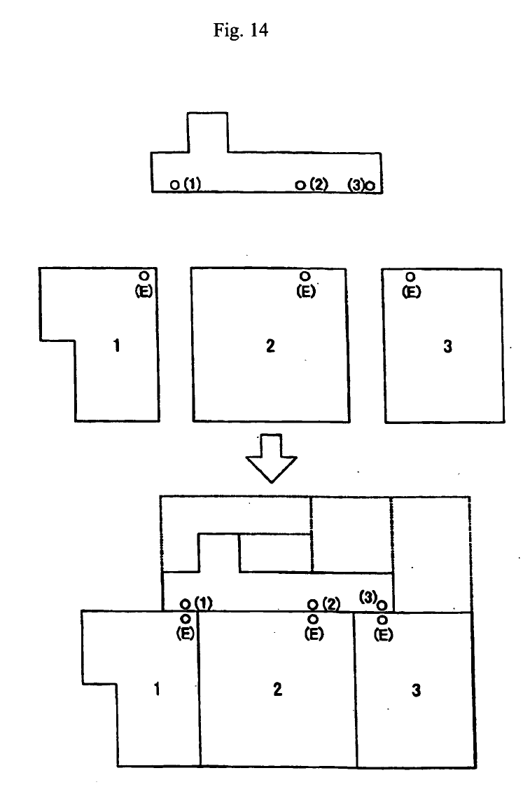

All rooms and a hall should be mapped with the abovementioned procedure and entrances to rooms in the hall should be marked via the marker 85. FIG. 14 shows a method of joining pieces of map information on the rooms and hall. All the rooms are numbered (1-3), the exits of the rooms are marked with E and the entrances from the hall to the rooms are numbered (1-3) so that the pieces of map information on the rooms are joined on a planar basis.

(3) Game Process

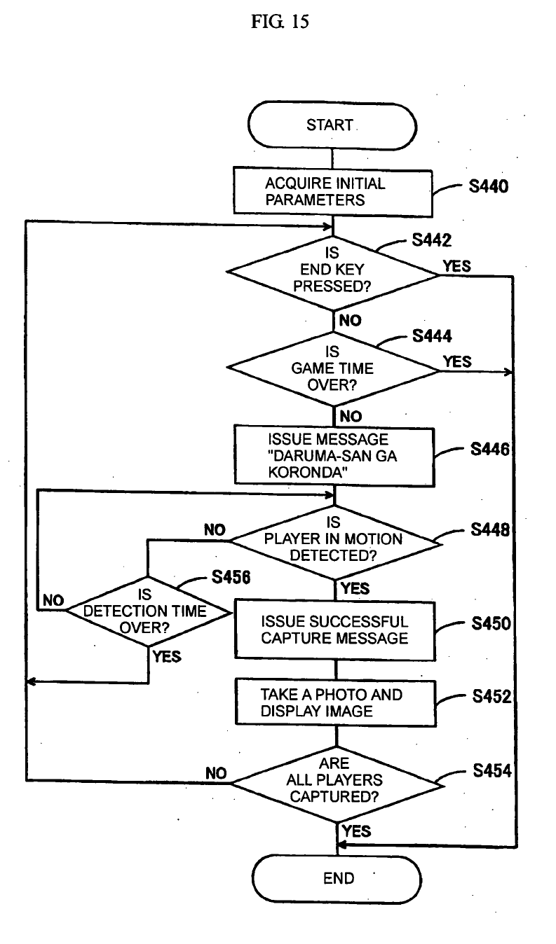

FIG. 15 is a flowchart showing the operation sequence of a program which the CPU 11 executes when the self-propelled cleaner performs the role of the chaser (capturer or tagger) in a given game. In this embodiment, the cleaner plays the game called “Daruma-san ga Koronda” (which means “Dharma is tumbling down”) with a human player (user). In the explanation below, the chaser in this game is called “Oni” and a person to be captured is called “Player”.

Next, the “Daruma-san ga Koronda” game will be briefly outlined. Usually the game is played by three or more persons. One person plays the role of Oni and the other persons play the role of Players. In the game, Oni closes his/her eyes and says loudly “Daruma-san ga koronda”. While Oni is saying this phrase, other players may move, but as soon as Oni finishes saying it, the players have to freeze. If Oni finds a player moving at that moment, Oni calls the name of the player and the player has to go to Oni and hold Oni's hand. The player is thus “captured” by Oni. This process is repeated until all players are captured by Oni. The second and subsequent captured players hold the hand of the players which have been captured before them. While Oni is saying the phrase, other (uncaptured) players gradually come closer to Oni taking care not to be captured. When an uncaptured player touches a captured player, the touched player is released.

The game explained next adopts a simplified version of the above rule: the player wins when he/she touches Oni.

At step S440, the CPU 11 acquires various initial parameters set by the user via the operation switches 15a and liquid crystal display panel 15b before starting the game. The user chooses the “Daruma-san ga Koronda” game from a given menu and also chooses whether to make the self-propelled cleaner execute the “Oni mode” or “Player mode” (in the case shown in FIG. 15, the “Oni mode” is chosen). When the “Oni mode” is chosen, the number of players participating in the game should be specified. In addition, the ability of the human sensors 21 which detect a player and the like (which will be stated later) are also selectable. The CPU 11 acquires these setup parameters.

At step S442, the CPU 11 checks whether the End key has been pressed and at step S444, checks whether the game time is over.

At step S446, the CPU 11 controls the sound output device 84 so that an audio message “Daruma-san ga koronda” is issued through the speaker. While the audio message is being issued, the player moves from a given start position toward the self-propelled cleaner. If the message is given slowly at times and quickly at other times, namely the speaking speed is varied, the game will be more exciting.

At step S448, after the message is ended, the humans sensors 21 are activated to detect whether there is a player in motion after the end of the message. Such detection lasts after the end of the message until a prescribed detection time elapses. As mentioned above, the CPU 11 acquires status information from the human sensors 21 at regular time intervals and if it finds change in status information from a human sensor 21, it considers that there is a player opposite that sensor. In the game, there is a player around the self-propelled cleaner and if the player stands still when the message is ended, status information from all the human sensors 21 remain unchanged and no player is detected. On the other hand, if the player is in motion after the end of the message, status information from a relevant human sensor 21 will change and the CPU 11 thus knows the presence of the player opposite that human sensor 21.

How the presence of a player is detected using the human sensors 21 has been described above. However, it may be difficult for the player to keep completely motionless and it may also be difficult for him/her to stop motion immediately after the end of the message. Therefore, in this embodiment, the detection ability of the human sensors 21 can be varied in several ways. For example, the lag time from the end of the message until activation of the human sensors 21 is selectable from several options: 0.5 sec, 0.8 sec, 1.2 sec and so on, or various options for a threshold value are available where the threshold value is used to assume the presence of a player if the amount of status change exceeds it. Also, the detection time may be selectable from several options: for example, 3 sec, 5 sec and 10 sec. When several options are available in each of aspects concerning the detection ability of the human sensors 21, the player can select the best options when setting the initial parameters. Consequently, the player can enjoy the game in a manner which is suitable for his/her age or game skill.

When a player in motion is detected during the above detection time, the CPU 11 controls the sound output device 84 so as to issue an audio message to tell successful capture of the player through the speaker (for example, “I've found it”).

At step S452, a command for photographing is given CMOS camera 61 and/or CMOS camera 62 to take a photo of the detected player and an image based on image data in the photo is displayed on the liquid crystal display pane 115b. For such photographing, both CMOS cameras 61 and 62 or either of them may be used. The CMOS cameras 61 and 62 are mounted in a way to face an area in front of the cleaner body but the detected player is not always in front of the body. Therefore, prior to such photographing, the CPU 11 calculates the relative angle between the position of the detected player and the area in front of the body and repositions the body so as to make its front face the player by turning it by the amount equivalent to the relative angle.

Instead of photographing in this embodiment, a means to emit an optical beam with a high directivity which is intense but safe enough may be provided to irradiate a detected player with the beam. When this method is used, the player can know easily that he/she has been captured, without looking at the liquid crystal display panel 15b.

An alternative approach is as follows. While the body has a means to emit a modulated optical beam or infrared light, the player wears an optical beam detection unit which detects reception of such a beam or light and a vest with an alarm which sounds in conjunction with the optical beam detection unit. If the alarm sounds upon detection of an optical beam, the game will be more exciting. In this case, desirably the beam directivity should be slightly weakened to ensure that the beam is detected as far as the player is opposite the body.

Concretely, the system works as follows.

The CPU 11 detects the relative angle between the player and the cleaner body on the basis of the result of detection by the human sensors 21fr, 21rr, 21f1 and 21r1. For measurement of the relative angle, the human sensors 21 detect either the infrared intensity of an infrared emitting object or simply the presence/absence of an infrared emitting object and outputs the result of detection.

When the human sensors 21 are designed to output infrared intensities, not a single human sensor 21 but several human sensors 21 may detect an infrared emitting object. The CPU 11 obtains the detection results of two human sensors 21 which output the highest intensities and detects the angle of the infrared emitting object within a 90-degree range zone between the detection ranges of the two human sensors. In this case, it calculates the intensity ratio of detection results of the two human sensors 21 and refers to a table prepared based on experimentation. This table stores the relationship between intensity ratio and angle. The table is used to find the angle of the object within the 90-degree range and the object's relative angle with respect to the cleaner body is calculated based on the locations of the two human sensors 21 whose detection results have been used. For example, if the human sensors 21fr and 21rr (located on the right side of the cleaner body) output the highest intensities and based on the ratio of their output intensities, 30 degrees on the human sensor 21fr side in the 90-degree range is obtained by reference to the table, then the relative angle of the object is 75 degrees (45 degrees+30 degrees) with respect to the front of the cleaner body (because it is 30 degrees within the 90-degree range on the front right side of the cleaner body).

On the other hand, when the human sensors 21 are designed to only detect the presence/absence of an infrared emitting object, the relative angle of the object is basically considered to be one of eight relative angles with respect to the cleaner body. Specifically, if only one human sensor 21 outputs a detection result, the angle of that human sensor 21 is regarded as the relative angle of the object; if two human sensors 21 output detection results, the middle angle between the angles of these two human sensors 21 is regarded as the relative angle of the object; and if three humans sensors 21 output detection results, the angle of the center human sensor among them regarded as the relative angle. In other words, when plural human sensors 21 are provided at regular intervals, if an even number of human sensors output detection results, the position of the object is considered to correspond to the middle point between two human sensors 21 concerned; and if an odd number of human sensors output detection results, its position is considered to correspond to the center human sensor 21.

Having obtained the relative angle in this way, the right and left drive wheels are driven to turn the cleaner body by the amount equivalent to the relative angle to make its front face the object. For the body to turn on the same spot, the CPU 11 orders the motor drivers 41R and 41L to turn the right and left drive wheel motors 42R and 42L in opposite directions by the prescribed amount. After the body is thus repositioned, the CPU 11 gives a command to take a photo and acquires the image data of the photo. The bus 14 and the camera communication I/O 63 are used to give a command to take a photo and acquire the image data.

When a player whose motion has been detected by a human sensor 21 is photographed and the photo image is displayed on the liquid crystal display panel 15b, which player has moved after the end of the message (“Daruma-san ga koronda”) is objectively determined. This method is particularly useful in identifying a captured player when more than one player participate in the game.

There may be a case that plural players have moved after the end of the message and a photo is taken based on detection by plural human sensors 21. In this case, it may happen that images of plural players appear in a screen frame or any image of a player is not completely within the frame. In order to deal with such a case, the CPU 11 may adopt a rule that a player whose image is the largest in the frame is regarded as captured.

At step S454, Oni checks whether all players have been captured. The number of successful capture messages issued as mentioned above is counted and if the count reaches the number of players acquired at step S440, it is considered that all players have been captured. If all players have been captured, the CPU 11 ends the game process (the winner is Oni).

By contrast, if all players have not been captured, or if no player has been detected during the detection time (yes at step S456), the self-propelled cleaner repeatedly issues the audio message “Daruma-san ga koronda” and attempts to capture a player.

At step S442, whether the End key is pressed or not is checked. The End key is a key which is located in a desired position on the surface of the cleaner body. The key may be one of the operation switches 15a or on a touch panel as the liquid crystal display panel 15b. When the CPU 11 detects that the End key has been pressed externally, the CPU 11 ends the game under way. In the Oni mode, if no player is captured by Oni and a player reaches Oni as a result of moving during repeated issuance of the message and presses the End key, the game is over (in this case, the player is the winner).

At step S444, whether the game time is over or not is checked. Here, the game time means a time period given for one play and is counted from when the game is started. If, during this game time, no player presses the End key and Oni fails to capture all players, the time runs out and the CPU 11 ends the game process (draw). Also, the CPU 11 may end the game process when an already captured player presses the End key during the game time in order to end the game.

Although the liquid crystal display panel 15b shows a photo image at step S452, an alternative approach is possible. For example, image data in the photo may be sent to the outside through the wireless LAN module 71. In other words, the image data is sent to a computer or the like which can communicate with the wireless LAN module 71 through an access point and stored there. After the game is over, an image based on the image data is displayed on the monitor of the computer so that the captured player can be checked.

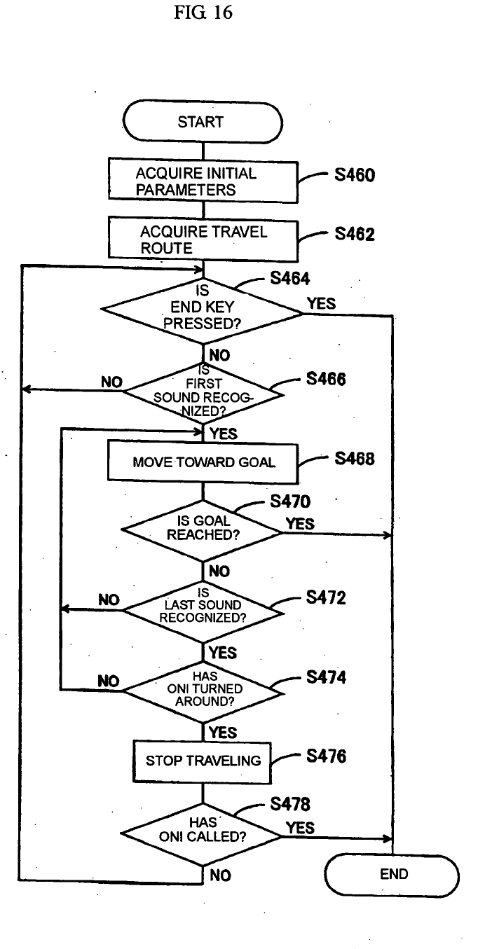

FIG. 16 is a flowchart of the operation sequence of a program which the CPU 11 executes when the self-propelled cleaner performs the role of Player in the “Daruma-san ga Koronda” game.

At step S460, the CPU 11 acquires various initial parameters set by the user through the operation panel unit 15. Referring to the figure, the user chooses the “Daruma-san ga Koronda” game from a given menu and the Player mode. When the Player mode is chosen, the user specifies a goal position for the self-propelled cleaner. Concretely, the user may specify one unit area in the map information completed by the mapping process (stated earlier) on a prescribed setup screen, or selects one of the special positions (SP1 to SP4) set on the marker 85 as the goal position. The CPU 11 stores the specified goal position as goal position information. Basically the goal position should be in the vicinity of a human player who plays the role of Oni.

At step S462, the CPU 11 acquires a travel route to the goal. First, the CPU 11 acquires the present position information from the map information and stores it. Then, it calculates the travel route from the present position to the stored goal position. To obtain the travel route, a known labyrinth solution may be used. For example, according to the right hand method, when you advance with your hand always on a wall surface along the advance direction, you can finally reach the goal. Then, redundant regions are deleted from the route sequentially. For example, shuttling regions before and after a 180-degree turn are deleted sequentially. Also, regions for a U turn in the room which can be skipped are found and deleted unless there is an obstacle in such regions. Instead of an automatic travel route calculation like this, an interface which allows the user to specify a travel route may be provided.

After the above steps are taken, the self-propelled cleaner is ready for participation in the game as Player.

At step S464, the CPU 11 checks whether the End key has been pressed or not. Then, at step S466, it checks whether Oni has uttered “da” (the first sound in the message “Daruma-san ga koronda”). This check is made by the sound recognition device 86. The sound recognition device 86 previously stores the first sound “da” and checks whether the similarity between the voice coming through the microphone and the previously stored first sound is within a prescribed range and if so, decides that the first sound has been uttered. In order to increase the sound recognition accuracy, “daru” or “daruma” may be used as the first sound instead of “da”.

After utterance of the first sound has been thus recognized, the cleaner body begins traveling toward the goal (step S468). During this travel, the CPU 11 continually checks whether the specified goal is reached or not (step S470) and checks through the sound recognition device 86 whether Oni has uttered the last sound “da” in the message (step S472). In other words, after the sound “da” is recognized while the body is not moving, the body begins moving; after the sound “da” is recognized while the body is moving, a step of checking output of the human sensors 21 as described below is taken. It is also possible that the stored last sound is different from the stored first sound: for example, a combination of “da” as the first sound and “nda” as the last sound or a combination of “daru” as the first sound and “da” as the last sound may be used. In this case, the step to be taken after every sound recognition is fixed.

After utterance of the last sound is recognized, at step S474 the CPU 11 checks whether Oni is turning around. How this check is made will be explained next. Let's assume that the CPU 11 calculates the relative angle between the front of the body and the goal at regular time intervals during traveling after step S468. Among the human sensors 21fr, 21rr, 21f1 and 21r1, a human sensor 21 nearest to the direction defined by the calculated relative angle is selected as the turnaround detection sensor. The selection of the turnaround detection sensor can vary depending on the position of the self-propelled cleaner in motion or the orientation of its front.

During traveling, in a situation that one of the human sensors 21fr, 21rr, 21f1 and 21r1 is selected as the turnaround detection sensor, the CPU 11 checks whether Oni is turning around, according to change in status information from the turnaround detection sensor. This is because Oni is in the vicinity of the goal as described above. For example, the CPU 11 acquires status information from the turnaround detection sensor at regular time intervals more than once and, if the amount of change in status information exceeds a prescribed threshold, decides that Oni is turning around.

If it is decided that Oni is turning around, at step S476 the body stops traveling. In other words, the self-propelled cleaner travels toward the goal and as soon as Oni finishes saying the message and turns around, the cleaner stops traveling in order to avoid being captured. Even when there is a player other than the cleaner, the human sensors 21 can also detect a human being other than Oni. However, since turnaround detection takes place only upon utterance of the last sound by Oni, in most cases the turnaround detection sensor, which detects a human movement in the direction of Oni, is considered to vary its output depending on Oni's movement. The cleaner body may stop moving in response to the movement of the other player coming close to Oni. However, the important thing is that the body stops before Oni finds it moving as Oni turns around. Therefore, it does not matter that the body stops moving because of movement of the other player. The method of detecting Oni's turn around is not limited to the above one. For instance, whether Oni is turning around or not may be decided from change in the skin-colored area of color images of the vicinity of the goal which are taken by the CMOS cameras 61 and 62.

At step S478, the CPU 11 checks whether the self-propelled cleaner has been called by Oni. If Oni turns around and finds the cleaner or another player moving, Oni calls the object in motion to capture it. The cleaner is called by a predetermined phrase. The sound recognition device 86 stores the predetermined phrase (for example, “I've found the cleaner”) and if the voice coming through the microphone is similar to the previously stored phrase to a prescribed extent, the CPU 11 decides that the cleaner has been called. If it is decided that the cleaner has been called by Oni, the CPU 11 considers that Oni has captured the cleaner and ends the game process (in this case, the cleaner is the loser). If it is not decided that the cleaner has been called by Oni, the cleaner waits on the spot for Oni to utter the message again (step S466).

The above steps are repeated and if the cleaner reaches the goal without being captured by Oni, the game is ended (Oni is the loser). In the series of steps, the CPU 11 occasionally loops back to the step of checking whether the End key is pressed or not (step S464). When the End key is pressed, the game is ended. In the Player mode, the End key is pressed in the following cases: the other player reaches Oni ahead of the cleaner and ends the game, or someone decides to stop the game for some reason before the game is over.

In the Player mode, in order to make the game more amusing, the level of the ability of detecting Oni's turnaround can be varied in several ways. For example, the lag time from recognition of the last sound until the CPU 11 receives status information from the turnaround detection sensor or the threshold against which change in status information is compared can be selected from several options; namely, when setting the initial parameters, the user can select the level of the turnaround detection ability from several options. Consequently, the user can enjoy the game with the cleaner at a level which is suitable for his/her age or play skill.

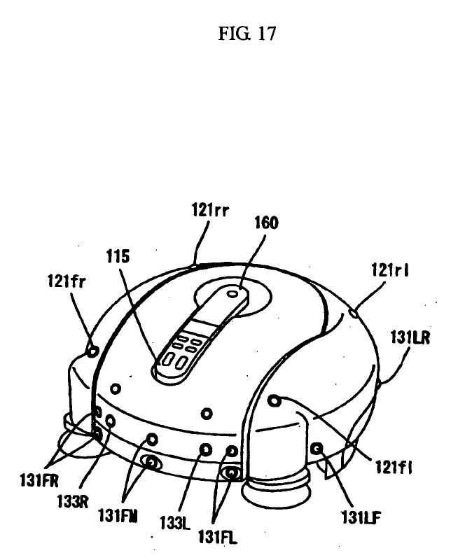

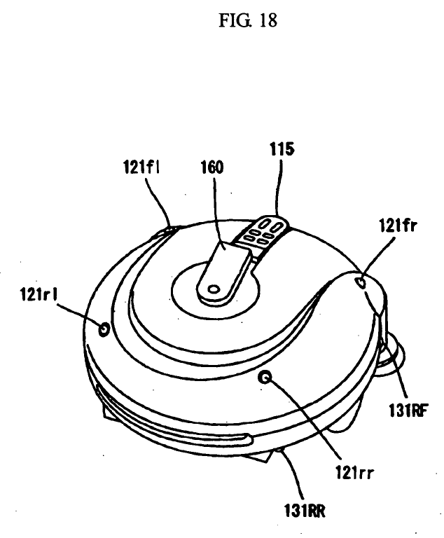

FIGS. 17 and 18 show another embodiment of this invention.

The human sensing unit 20 consists of four human sensors 121 (121fr, 121rr, 121f1, 121r1) where two of them are disposed obliquely at the left and right sides of the front of the body and the other two obliquely at the left and right sides of the rear of the body. Each human sensor 121 has an infrared light-receiving sensor that detects the presence of a human body based on change in the amount of infrared light received.

The obstacle monitoring unit 30 uses ultrasonic sensors instead of front AF ranging sensors. In this embodiment, the forward area, which is covered by the front AF passive sensors 31FR, 31FM and 31FL in the first embodiment, is covered by ultrasonic sensors 131FR, 131FM and 131FL. Each of the ultrasonic sensors consists of a pair of a ultrasonic transmitter unit and a ultrasonic receiver unit. Ultrasonic waves transmitted from the ultrasonic transmitter unit and reflected by an obstacle are received by the ultrasonic receiver unit and the presence/absence or distance of an obstacle is determined according to the time lag or phase lag.

For detection for a wall surface, for which the AF passive sensors 31R and 31L are responsible in the first embodiment, photo-reflectors 131 RF, 131RR, 131LF and 131LR are provided. The photo-reflectors 131RF and 131LF are located at the front side faces of the body and, like the AF passive sensors 31R and 31L, cover the forward area beside the front part of the body to detect a wall or measure the distance to a wall. The photo-reflectors 131RR and 131LR cover the backward area beside the rear part of the body to detect a wall or measure the distance to a wall. While in the first embodiment only the forward area is covered by the AF passive sensors 31R and 31L to detect a wall or measure the distance to a wall, in this embodiment the backward area is also covered by the photo-reflectors 131RR and 131LR to detect a wall or measure the distance to a wall. This means that as the body spins, a wall can be detected or the distance to a wall can be measured as necessary. Each of the photo-reflectors consists of a light emitter unit and a light receiver unit and light emitted from the light emitter unit and reflected by an obstacle is received by the light receiver unit and the presence/absence or distance of an obstacle is determined according to the amount of light received.

The photo-reflectors 131RF and 131LF cannot perform detection of a step or floor level difference, for which the AF passive sensors 31R and 31L are responsible in the first embodiment. Instead, downward-pointing photo-reflectors (not shown) are provided on the periphery of the bottom of the body. These downward-pointing photo-reflectors detect a step, particularly a staircase or the like.

In this embodiment, the ultrasonic sensors 131FR, 131FM and 131FL detect an obstacle ahead; the photo-reflectors 131RF and 131LF detect a wall beside the body and measure the distance to a wall; and the photo-reflectors (not shown) on the bottom of the body detect a step ahead on the floor. Thus the functions of these components replace virtually all the functions in the first embodiment. Also, obviously, for the same purpose, operation control can be done taking advantage of the special features of the ultrasonic sensors and photo-reflectors.

1. A self-propelled cleaner which includes a body having a cleaning mechanism with a suction motor for vacuuming up dust and a drive mechanism with drive wheels at the left and right sides of the body whose rotation can be individually controlled for steering and driving the cleaner, and can perform a game function, comprising:
a sound output processor which can make a prescribed sound;
a human body detection processor which checks whether there is a human body moving nearby;
an imaging device which takes an image and outputs a taken image as image data;
an image display processor which displays an image based on the image data;
a game control processor which makes the sound output processor issue a prescribed successful capture message when the human body detection processor detects a player in motion after the end of each cycle of a prescribed game message repeatedly issued by the sound output processor at prescribed times and makes the imaging device take an image of the player and makes the image display processor display the image and, when a predetermined number of players are detected or when it is detected that a given game end key provided on the body has been pressed while the game message is being issued, ends the game; and
a human body detection ability adjustment processor which adjusts the human body detection processor's ability of detecting a player in motion, in plural steps.

2. A self-propelled cleaner which has a body with a cleaning mechanism, and a drive mechanism capable of steering and driving the cleaner and can perform a game function, comprising:
a sound output processor which can make a prescribed sound;
a human body detection processor which checks whether there is a human body moving nearby; and
a game control processor which, when the human body detection processor detects a player in motion after the end of a prescribed game message issued by the sound output processor, notifies the outside of that detection, and when the human body detection processor detects a predetermined number of players or when a given instruction to end the game is received from the outside while the game message is being issued, ends the game.

3. The self-propelled cleaner as described in claim 2, wherein the human body detection processor's ability of detecting a player in motion can be adjusted in plural steps.

4. The self-propelled cleaner as described in claim 2, wherein the sound output processor issues a prescribed message notifying of a successful capture when the human body detection processor detects a player in motion.

5. The self-propelled cleaner as described in claim 2, wherein, when the human body detection processor detects a player in motion, a given imaging device takes an image of the player and a given image display processor displays the image.

6. The self-propelled cleaner as described in claim 2, wherein a wireless LAN communication device which can transmit given information to the outside is provided and, when the human body detection processor detects a player in motion, the game control processor makes a given imaging device take an image of the player and sends the acquired image data to the outside through the wireless LAN communication device.

7. The self-propelled cleaner as described in claim 2, further comprising:
a travel route calculation processor which acquires and stores map information on a room while the cleaner is traveling around the room for cleaning it and acquires positional information on a given goal in the map information and calculates the travel route from the present position to the goal position; and
a sound recognition processor capable of recognizing sound, wherein
when a chasee mode in a game is selected, the game control processor starts traveling toward the goal along the travel route by means of the drive mechanism as soon as the sound recognition processor recognizes the first sound of a game message uttered by a player, and stops the traveling as soon as the sound recognition processor recognizes the last sound of the game message and the human body detection processor detects that the player turns around, and ends the game when the goal is reached or when the sound recognition processor recognizes a prescribed successful capture message uttered by a player.
